(19) United States
(12) Patent Application Publication
(10) Pub. No.: US 2025/0327236 A1
(43) Pub. Date: Oct. 23, 2025

(54) MICROPARTICLES FILTER DEVICE FOR A LAUNDRY WASHING MACHINE, THE DEVICE BEING PROVIDED WITH A CLEANING DEVICE AND METHOD FOR REMOVING THE CLEANING DEVICE

(71) Applicant: ELECTROLUX APPLIANCES AKTIEBOLAG, Stockholm (SE)

(72) Inventors: Paolo CESCOT, Porcia (IT); Andrea CONTARINI, Porcia (IT); Marco MAIERO, Porcia (IT); Maurizio DEL POS, Porcia (IT); Carlo Antonio LEONE, Porcia (IT); Andrea ZATTIN, Porcia (IT); Stefano DE PAOLI, Porcia (IT); Marco PESSOT, Porcia (IT); Mattia RUSALEN, Porcia (IT)

(73) Assignee: ELECTROLUX APPLIANCES AKTIEBOLAG, Stockholm (SE)

(21) Appl. No.: 18/871,393

(22) PCT Filed: Jun. 9, 2022
(86) PCT No.: PCT/EP2022/065722

§ 371 Date: Dec. 3, 2024

(51) Int. Cl. D06F 39/10; B01D 29/35; B01D 29/64; B01D 29/94; B01D 35/16

(52) U.S. Cl. CPC D06F 39/10; B01D 29/35; B01D 29/6476; B01D 29/6484; B01D 29/94; B01D 35/16; B01D 2201/325; B01D 2201/4092

(57) ABSTRACT

A microparticles filter device with a housing body, an inlet and an outlet, a filtering chamber housed in the housing body and including a microparticles filter element having a filtering surface on which microparticles accumulate while the liquid flows therethrough; a cleaning device movably arranged in the filtering chamber for removing microparticles that accumulate on the filtering surface towards a storage volume of a collecting chamber arranged at a side of the filtering chamber and in communication therewith, where the collecting chamber is configured to be removably coupled with respect to the housing body and the cleaning device includes at least a portion extending into the storage volume of the collecting chamber thereby providing an extraction aid member to remove the cleaning device from the housing body when the collecting chamber is removed from the housing body.

### FIELD OF THE INVENTION

The present invention concerns the field of microparticles filtration systems, in particular microparticles filtration systems in laundry washing machines.

Specifically, the invention relates to a microparticles filter device for a laundry washing machine wherein the device is provided with a cleaning device. The invention also relates a method for removing the cleaning device.

### BACKGROUND ART

Nowadays, the topic of microparticles/microplastics that contribute to environmental pollution is an issue that is of particular concern to public opinion.

In particular, a main issue relates to the environmental impact of microparticles/microplastics released from laundry.

As known, in laundry washing machine laundry to be washed is received in a rotatable washing drum contained in a washing tub.

It is known that during laundry washing cycles, laundry undergoes to mechanical and/or chemical treatments inside the washing drum with the use of a washing liquor, typically water with the possible addition of washing/rinsing products such as detergent, softener, rinse conditioner, etc.

Laundry to be treated in a laundry washing machine typically comprises clothes and linens made of natural or synthetic fabrics. During washing and/or rinsing treatments, laundry loses tiny particles, called microparticles or microfibers. In particular, clothes comprising synthetic materials lose tiny plastic particles fibres, called microplastics, which are non-biodegradable.

Microparticles/microplastics end up in the wastewater drained from the laundry washing machine and eventually end up in the environment contributing to environmental pollution. For example, microplastics washed off from laundry greatly contribute to plastic that is polluting seas and oceans.

Different solutions have been proposed in known laundry washing machines by arranging a microparticles filter to capture microparticles and reduce their drainage in the wastewater.

A first known system for microparticles filtration used in a laundry washing machine is disclosed in WO2019081013A1. Here a microparticles filter is arranged along a re-circulation line that takes liquid from the bottom of the washing tub and conveys the same in an upper point of the same washing tub.

The microparticles filter comprises a filtering element, or filter membrane, arranged in a filtering chamber of the filter. According to some embodiments disclosed therein, a cleaning device is movably arranged in the filtering chamber for removing microparticles that accumulate on the filter membrane.

Microparticles removed from the filter membrane by the cleaning device are pushed towards a microparticles collecting chamber arranged at a side of the filtering chamber and separated therefrom. Removed microparticles enter the microparticles collecting chamber through an opening closed by a controllable flap. The collecting chamber is then accessible from outside to a user via a door realized on the outer cabinet of the machine so that it can be removed manually.

In such known known system for microparticles filtration the removal of the collecting chamber requires a lot of attention for the user handling the various parts of the machine. The collecting chamber is in fact subjected to a humid or wet conditions and microparticles may be unintentionally dispersed in the environment. Heating means have been provided for drying microparticles within the collecting chamber, however such solution requires to provide electrical arrangements in a wet environment that must be handled by a user. So, a high level of difficulty has to be overcome to properly design and provide an electrical system to dry microparticles within the collecting chamber to ensure a high level of safety in terms of electrical and high temperature risk prevention for a user and for the overall filtration device.

Furthermore, in said microparticles filters the filter membrane may be subject to a certain level of clogging over time despite the wiping action of the cleaning device causing technical difficulties in maintenance.

Another known system for microparticles filtration used in laundry washing machine is disclosed in WO2020089727A1. Here an assembly comprising a microparticles filter group is positioned along a drainage hose and a filter body houses the filter group. The assembly is made in cylindrical shape and is insertable/removable as a cartridge through an opening made on an outer washing machine wall to allow maintenance and replacement operations of the filter group.

The assembly is arranged in the lower right side of the machine and the drainage hose extends vertically up to its upper end protruding outside the machine.

A drainage pump group is also positioned along the drainage hose and is connected to the filter assembly. When the drainage pump group operates, the liquid is filtered by the filter group and then expelled to the outside through the drainage hose. When the drainage pump group is not operating, for example at the end of a washing cycle, a user may intervene for maintenance by extracting the filter assembly from the washing machine wall.

A drawback of this system arises after the drainage pump group is stopped when residue liquid may remain inside the filter body housing. Residue liquid may favour proliferation of bacteria and yeasts, which may worsen the hygienic conditions and/or may cause bad smells.

A further drawback of this known system arises when the filter assembly is extracted from the washing machine cabinet wall. After the drainage pump group is stopped, in fact, residue liquid may remain inside the filter body. When the filter assembly is extracted from the washing machine said residue liquid may spill outside the machine and eventually falling on the floor. This makes maintenance operations uncomfortable for a user, who has to manage periodical filter cleaning and/or substitution operation acting on a heavily wet environment with the risk of getting dirty or even dispersing collected microparticles around the washing machine.

The object of the present invention is therefore to overcome the drawback posed by the known techniques.

An object of the present invention is therefore to provide a solution that allows maintenance of the filtering element, such as cleaning or replacing operations of the filtering element.

Another object of the present invention is to develop a filtering system in a laundry washing machine that assures easy accessibility to the filtering element during maintenance.

Still a further object of the present invention is to reduce the risk of getting dirty when operating on a microparticles filter device.

Another object of the invention to provide a solution that makes it possible to reduce proliferation of bacteria and/or yeasts therefore improving hygienic conditions.

### DISCLOSURE OF INVENTION

Applicant has found that by providing a microparticles filter device having a microparticles filter element having a filtering surface on which microparticles accumulate while the liquid flows therethrough and a cleaning device for removing microparticles accumulated on said filtering surface and moving the microparticles towards a collecting chamber and by providing the cleaning device with a portion extending into the collecting chamber it is possible to reach the mentioned objects. In a first aspect thereof the present invention relates, therefore, to a microparticles filter device for a laundry washing machine, said microparticles filter device comprising:
a housing body;
an inlet for liquid to be filtered;
a filtering chamber housed in said housing body, said filtering chamber comprising a microparticles filter element having a filtering surface on which microparticles accumulate while said liquid flows therethrough;
an outlet for filtered liquid;
a cleaning device movably arranged in said filtering chamber for removing microparticles that accumulate on said filtering surface, said cleaning device moving microparticles removed from said filtering surface towards a storage volume of a collecting chamber arranged at a side of said filtering chamber and in communication therewith;
   wherein said collecting chamber is configured to be removably coupled with respect to said housing body and wherein said cleaning device comprises at least a portion extending into said storage volume of said collecting chamber thereby providing an extraction aid member to remove said cleaning device from said housing body when said collecting chamber is removed from said housing body.

Advantageously, the collecting chamber, when coupled with the housing body of the microparticles filter device, closes an opening, which is provided in said housing body, through which, or by means of which, an extraction aid member can be reached by a user to remove the cleaning device from the housing body. In one embodiment, the extraction aid member can be removed from the housing body by passing the cleaning device through said opening.

In a preferred embodiment, the collecting chamber is embodied as a cap for closing an opening provided in the housing body.

In a preferred embodiment, the portion of the cleaning device extending into the storage volume, provided in said collecting chamber to accumulate microparticles, occupies a volume portion of the storage volume ranging from 2% to 30%, or 25% or 20% or 15% or 10% or 8% or 5% of the overall storage volume. The volume portion occupied by the portion of the cleaning device extending into said storage volume is dimensioned according to the microparticles accumulation capacity that has to be assigned to the microparticles filter device. This has beneficial advantages on increasing the number of laundry treatments that the machine can perform without emptying the collecting chamber.

In an embodiment of the invention, the cleaning device extends into the storage volume of said collecting chamber, along an extension direction which is ranging from 15% to 100% of the storage volume extension along the same direction.

In an embodiment of the invention wherein the cleaning device extends into the storage volume of the collecting chamber along an extension direction which is lower than 100% of the storage volume extension along the same direction, the cleaning device has a cantilever end portion inside the storage volume, i.e. inside the collecting chamber.

Advantageously, when the collecting chamber is removed from the housing body the portion of the cleaning device extending into the collecting chamber may be used as an extraction aid member to remove the cleaning device. After removal of the cleaning device, the microparticles filter element is advantageously accessible for a proper cleaning process.

Preferably, the filtering chamber is formed by a portion of the housing body.

In a preferred embodiment, the microparticles filter element is removably arranged in the filtering chamber.

Advantageously, the microparticles filter element may be extracted out from the filtering chamber and from the housing body for a proper cleaning process or substitution, if necessary.

Further advantageously, the microparticles filter element may be extracted out from the filtering chamber and from the housing body through an opening provided in the housing body.

In one embodiment the same opening provided in the housing body allows the extraction of the cleaning device and the microparticles filter element from the housing body.

Preferably, the cleaning device is configured to be removably coupled to the filtering chamber.

Advantageously, the cleaning device may be easily extracted out from the filtering chamber so that the microparticles filter element and its filtering surface are advantageously accessible from outside. A user may hence advantageously reach the microparticles filter element and its filtering surface for a proper cleaning process.

According to a preferred embodiment of the invention, the cleaning device comprises a rotatable element apt to remove microparticles that accumulate on the filtering surface.

In a preferred embodiment, the rotatable element comprises a worm comprising a first end shaft body, a second end shaft body and a helix-shaped element connecting the end shaft bodies and winding around a main axis.

Preferably, the rotatable element further comprises a central shaft body extending along the main axis between the first and second end shaft bodies, wherein the helix-shaped element winds around the central shaft body.

Advantageously, the rotatable element wipes a side of the filtering surface of the microparticles filter element and moves microparticles towards the collecting chamber, acting as a worm conveyor.

According to a preferred embodiment of the invention, the helix-shaped element at least partially extends into the collecting chamber.

Advantageously, microparticles moved towards the collecting chamber are pressed therein maximizing the storage of microparticles inside the collecting chamber.

In a further preferred embodiment, the cleaning device comprises a translatable element provided for wiping a side of the filtering surface, said translatable element preferably comprising a piston.

Preferably, an actuating device is provided for moving the cleaning device.

According to a preferred embodiment of the invention, the actuating device comprises an electric motor.

In a preferred embodiment, the cleaning device and the collecting chamber are removably coupled one another, so that when the collecting chamber is removed from the housing body the collecting chamber is disconnected from the cleaning device.

In a further alternative preferred embodiment, the cleaning device and the collecting chamber are removably connected one another by means of a releasable locking device, so that they can be disconnected one from the other by releasing the releasable locking device after being unitarily removed from said housing body.

According to a preferred embodiment of the invention, the collecting chamber is screwable to the housing body.

Advantageously, the collecting chamber may be easily disconnected/connected from/to the housing body.

In a preferred embodiment, the microparticles filter element is a disposable filter element.

According to a preferred embodiment of the invention, the microparticles filter device further comprises a second outlet provided in a sump portion of the housing body and downstream the microparticles filter element. The second outlet is provided for draining filtered liquid, that is collected in the sump portion, from the latter out of said housing body.

Preferably, the filtered liquid flows through the second outlet either when a liquid flow entering the inlet of the microparticles filter device is passed through the microparticles filter element or when no liquid flow enters said inlet and an amount of filtered liquid is received in the sump portion.

Advantageously, when the microparticles filter device is not working, the residue liquid inside the filtering chamber exits the second outlet and drained outside the housing body so that the filtering chamber remains completely emptied. Removal of any residue liquid in the filtering chamber avoids proliferation of bacteria and/or yeasts thus improving hygienic conditions and preventing bad smells.

Preferably, the microparticles filter device is a filter suitable to retain particles having a minimum dimension comprised between 0.1 μm and 5 mm, preferably a minimum dimension comprised between 10 μm and 100 μm, more preferably a minimum dimension comprised between 10 μm and 75 μm.

Advantageously, the microparticles filter device is suitable to retain particles present in the waste liquid produced by mechanical and/or chemical treatments of the laundry inside the washing drum, preferably tiny plastic particles released by the laundry, also indicated as microplastics, which are non-biodegradable.

In a further aspect thereof, the present invention relates to a method for removing a cleaning device of a microparticles filter device realized as described above, wherein the method comprises the steps of:
removing said collecting chamber from said housing body;
removing said cleaning device from said housing body by means of said extraction aid member.

In a preferred embodiment, the step of removing the cleaning device from the housing body by means of the extraction aid member is performed after the step of removing the collecting chamber from the housing body wherein, after the collecting chamber has been removed, the extraction aid member is accessible to a user.

In a further preferred alternative embodiment, the step of removing the collecting chamber from the housing body and the step of removing the cleaning device from the housing body are performed simultaneously, wherein the collecting chamber and the extraction aid member remain engaged while the collecting chamber is removed from the housing body. In this case, preferably, the method further comprises a step of disengaging the extraction aid member from the collecting chamber after the extraction aid member and the collecting chamber have been simultaneously removed from the housing body.

According to a preferred embodiment of the invention, if the microparticles filter device includes a second outlet then, before the step of removing the collecting chamber from the housing body, filtered liquid collected in a sump portion of the housing body is drained outside the housing body through the second outlet.

Advantageously, the filtering chamber remains completely emptied avoiding proliferation of bacteria and/or yeasts thus improving hygienic conditions and preventing bad smells.

### BRIEF DESCRIPTION OF THE DRAWINGS

Further characteristics and advantages of the present invention will be highlighted in greater detail in the following detailed description of some of its preferred embodiments, provided with reference to the enclosed drawings. In the drawings, corresponding characteristics and/or components are identified by the same reference numbers. In particular:

FIG. 1 shows a frontal view of a laundry washing machine according to a first embodiment of the invention;

FIG. 2 shows a schematic view of the laundry washing machine of FIG. 1;

FIG. 3 shows a lateral view of the laundry washing machine of FIG. 1 with an external side wall removed therefrom;

FIG. 4 shows the microparticles filter device of the laundry washing machine of FIG. 3 isolated from the rest;

FIG. 5 is a longitudinal sectional view of the microparticles filter device of FIG. 4;

FIG. 6 shows the microparticles filter device of FIG. 5 in a first operating position;

FIG. 7 shows an exploded view of the microparticles filter device of FIG. 5;

FIG. 8 shows a longitudinal sectional view of a further embodiment of the microparticles filter device of the invention in a first operating position;

FIG. 9 shows an enlarged detail of FIG. 8;

FIG. 10 shows a further embodiment of an element of the microparticles filter device according to the invention;

FIG. 11 shows a further embodiment of FIG. 5 according to a further embodiment of the microparticles filter device of the invention;

FIG. 12 shows a schematic view of the laundry washing machine of the invention according to a further embodiment of the invention;

FIG. 13 shows a further embodiment of FIG. 4 according to a further embodiment of the microparticles filter device of the invention;

FIG. 14 is a longitudinal sectional view of the microparticles filter device of FIG. 13;

FIG. 15 shows the microparticles filter device of FIG. 14 in a first operating position;

FIG. 16 shows an exploded view of the microparticles filter device of FIG. 14;

FIG. 17 shows a schematic view of the laundry washing machine of the invention according to a further embodiment of the invention.

### DETAILED DESCRIPTION OF PREFERRED EMBODIMENTS OF THE INVENTION

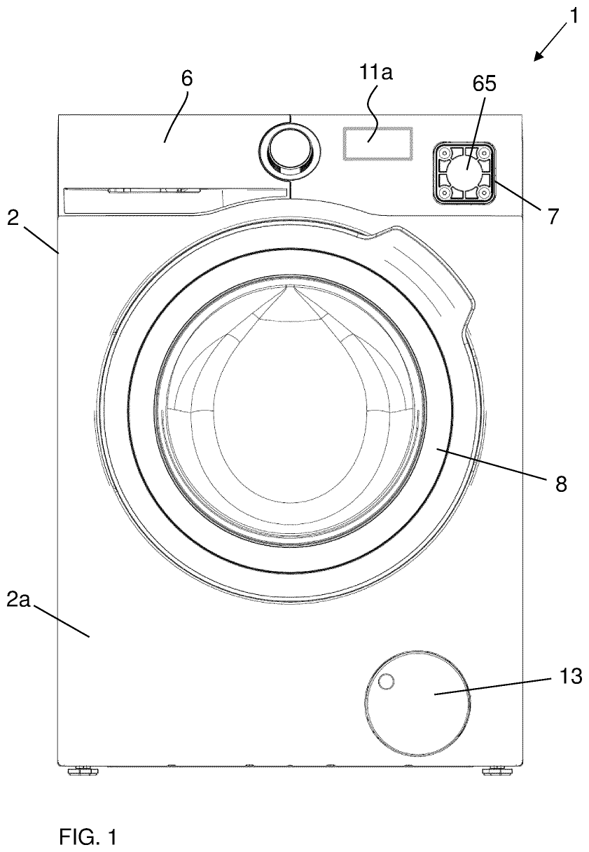

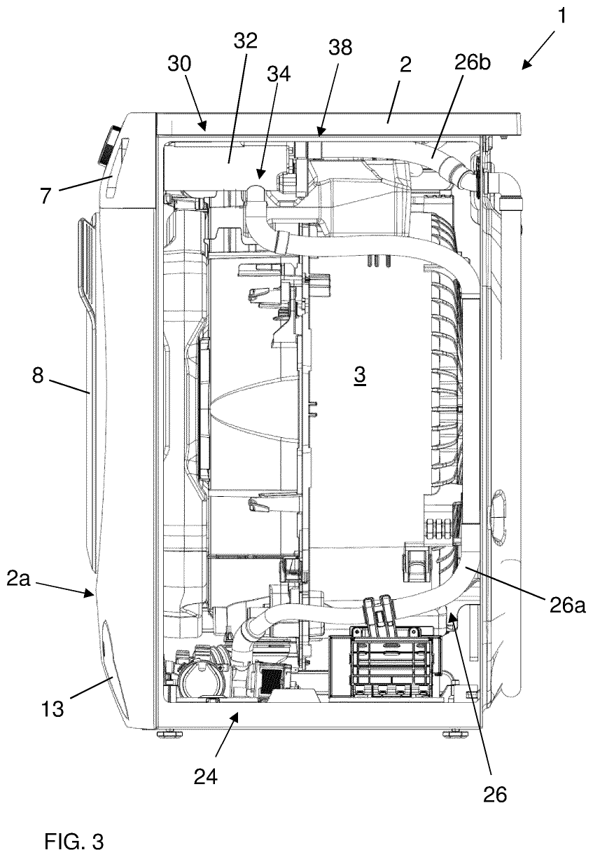

FIGS. 1 to 3 show a laundry washing machine 1 equipped with a microparticles filter device 30 according to a preferred embodiment of the invention.

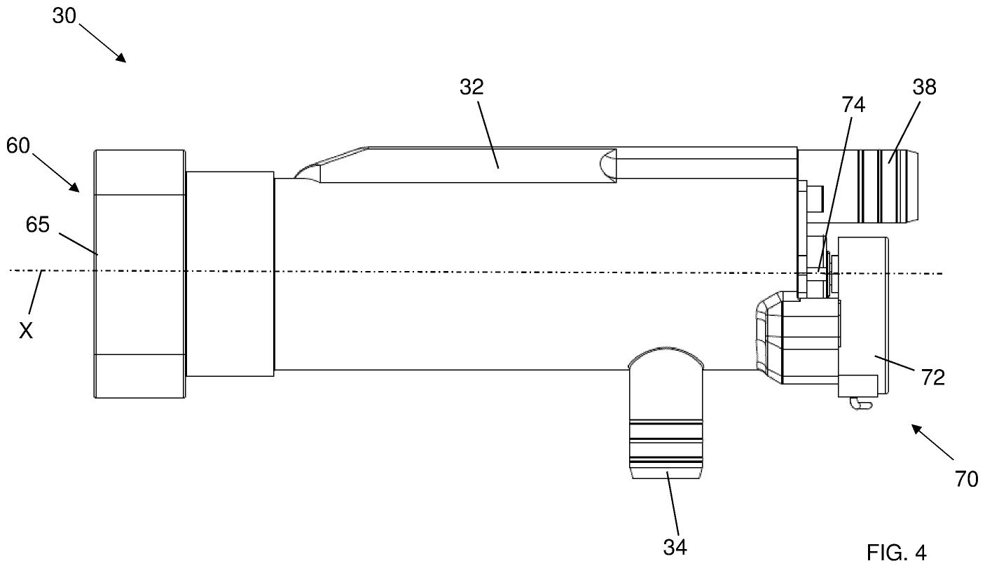

FIGS. 4 to 7 show the microparticles filter device 30 according to a preferred embodiment of the invention.

The microparticles filter device 30 according to the invention is particularly advantageous when applied to laundry washing machines, i.e. appliances able to carry out at least a washing process on laundry and optionally further able to perform a drying process on laundry. In this view the microparticles filter device of the present invention can be applied to laundry washing and drying machines.

The laundry washing machine 1 preferably comprises an external casing or outer cabinet 2, a washing tub 3, a container 4, preferably a perforated washing drum 4, where the laundry to be treated can be loaded.

The washing tub 3 and the washing drum 4 both preferably have a substantially cylindrical shape.

The cabinet 2 at its front side wall 2a is provided with a loading/unloading door 8 which allows access to the washing drum 4.

The washing drum 4 is advantageously rotated by an electric motor, as known in the art, which preferably transmits the rotating motion to the shaft of the washing drum 4, advantageously by means of a belt/pulley system. In a different embodiment of the invention, the motor can be directly associated with the shaft of the washing drum 4.

The washing drum 4 is advantageously provided with holes or apertures which allow the liquid flowing therethrough. Said holes are typically and preferably homogeneously distributed on the cylindrical side wall of the washing drum 4.

The bottom region 3a of the washing tub 3 preferably comprises a seat 15, or sump, suitable for receiving a heating device 10. The heating device 10, when activated, heats the liquid collected inside the sump 15.

In further embodiments, other type of heating device may be advantageously placed in the machine 1 to heat liquid.

Preferably, the laundry washing machine 1 comprises a device 19 suited to sense (or detect) the liquid level inside the washing tub 3.

The sensor device 19 preferably comprises a pressure sensor which senses the pressure in a chamber formed in, or connected to, the washing tub 3. Such chamber can be partially filled by the liquid contained in the washing tub 3, thereby modifying the pressure in the unfilled portion of said chamber. From the pressure values sensed by the sensor device 19 it is possible to determine the liquid level of the liquid inside the washing tub 3. In another embodiment, not illustrated, laundry washing machine may preferably comprise (in addition to or as a replacement of the pressure sensor) a level sensor (for example mechanical, electro-mechanical, optical, etc.) adapted to sense (or detect) the liquid level inside the washing tub 3. A liquid (water) supply system 5 is preferably arranged in the upper part of the laundry washing machine 1 and is suited to supply water into the washing tub 3 from an external water supply line E. The water supply system 5 preferably comprises a controlled supply valve 5a which is properly controlled, opened and closed, during a washing cycle to properly carry out all the phases thereof. The water supply system of a laundry washing machine is well known in the art, and therefore it will not be described in detail.

Liquid supply system refers, in general, to any system apt to supply water or any liquid into the tub.

The laundry washing machine 1 advantageously comprises a treating agents dispenser 14 to supply one or more treating agents into the washing tub 3 during a washing cycle. Treating agents may comprise, for example, detergents, rinse additives, fabric softeners or fabric conditioners, waterproofing agents, fabric enhancers, rinse sanitization additives, chlorine-based additives, etc.

Preferably, the treating agents dispenser 14 comprises a removable drawer 6 provided with various compartments suited to be filled with the treating agents.

In the preferred embodiment here illustrated, the water is supplied into the washing tub 3 from the water supply system 5 by making it flow through the treating agents dispenser 14 and then through a supply pipe 18. The provision of the treating agents to the washing tub 3 may be performed by automatically dosing an amount of said agents before delivering them to the washing tub 3. Such dosage is preferably performed by a dosing device having metering means for measuring a desired amount of an agent to be taken from a treating agent storage and delivered to the washing tub 3.

In an alternative embodiment of the invention, a further separate water supply pipe can be provided, which supplies exclusively clean water into the washing tub from the external water supply line.

In further preferred embodiments, not illustrated herein, a water softening device may preferably be arranged/interposed between the external water supply line and the treating agents dispenser so as to be crossed by the fresh water flowing from the external water supply line. The water softening device, as known, is structured for reducing the hardness degree of the fresh water drawn from the external water supply line and conveyed to the treating agents dispenser.

In a different embodiment, the water softening device may be arranged/interposed between the external water supply line and the washing tub, so as to be crossed by the fresh water flowing from the external water supply line and conveying it directly to the washing tub.

Laundry washing machine 1 preferably comprises a draining system 20 to drain liquid outside the cabinet 2 up to a drainage (not shown). More preferably the draining system 20 withdraws liquid from the bottom region 3a of the washing tub 3 and drains it outside the cabinet 2.

The draining system 20 preferably comprises a main pipe 22, a draining pump 24 and an outlet pipe 26 ending outside the cabinet 2.

Preferably, the draining pump 24 is a centrifugal pump provided with a rotating component, or impeller, that moves the liquid to a pump fluid outlet 24a.

The draining system 20 preferably further comprises an objects filter device 28 arranged between the main pipe 22 and the draining pump 24.

The objects filter device 28 is adapted to stop objects before they reach the draining pump 24. The objects filter device 28 has the aim of retain undesirable objects that may damage the draining pump 24, for example may damage the impeller in case a centrifugal pump design is used.

Said kind of objects, also indicated hereinafter as coarse material, may comprise, for example, buttons, coins, screws, needles, paper clips, pieces of clothes, etc.

Preferably, the objects filter device 28 is suitable to filter objects having a maximum dimension higher than 5 mm.

In a preferred embodiment, the objects filter device preferably comprises a casing having a housing wherein a objects filter element is received. The housing preferably forms a channel through which liquid to be filtered flows. Said objects filter element is preferably provided with a meandering structure, for example in the form of tabs that are arranged along the channel when the objects filter element is placed within the housing so as to create a labyrinthic path through which the liquid flows while objects are stopped by the tabs.

For cleaning purposes, the objects filter device 28 can preferably be removed from the housing and from the cabinet 2 through an openable gate 13 placed advantageously on the front side wall 2a of the cabinet 2, as illustrated in FIG. 1.

The objects filter device 28 and respective gate 13 are arranged in the lower part of the laundry washing machine 1, more preferably in the lower right side of the laundry washing machine 1.

The draining pump 24 and the objects filter device 28 are preferably embodied as a group assembly, for example by directly connecting the draining pump 24 to the casing defining the housing of the objects filter device 28.

The main pipe 22 preferably connects the bottom region 3a of the washing tub 3 to the objects filter device 28.

In a further embodiment, not illustrated, the casing of the objects filter device may be provided directly in the washing tub, preferably obtained in a single piece construction with the latter. In this case, the objects filter device is fluidly connected to the outlet of the washing tub, in such a way that liquid drained from the washing tub enters the objects filter device.

Activation of the draining pump 24 drains the liquid, i.e. water or water mixed with washing and/or rinsing products, from the washing tub 3 to the outside.

Laundry washing machine 1 advantageously comprises a control unit 11 which is in signal and/or electrical communication to the various operational parts of the laundry washing machine 1 such as drum motor, sensors, etc., in order to ensure its operation for carrying out a laundry treating program. The control unit 11 is advantageously connected also to an interface unit 11a which is accessible to the user and by means of which the user selects and sets the washing parameters from time to time, in particular a desired laundry washing or treating program.

According to an aspect of the invention, the microparticles filter device 30 is preferably associated to the laundry washing machine 1.

According to the preferred embodiment shown in FIGS. 1 to 3, the microparticles filter device 30 is preferably arranged within the cabinet 2, in a flow path between the water supply system 5 and the draining system 20. Preferably, the microparticles filter device 30 is arranged in the draining system 20, preferably along the outlet pipe 26 of the draining system 20, more preferably in a portion of said outlet pipe 26 contained within the volume defined by the cabinet 2.

The microparticles filter device 30 is then preferably arranged downstream the fluid outlet 24a of the draining pump 24.

Before the liquid reaches a drainage outside the machine 1, liquid is therefore subjected to a filtration process preventing microparticles leaving the laundry washing machine 1.

The microparticles filter device 30 is configured to retain particles having a minimum dimension comprised between 0.1 μm and 5 mm, preferably a minimum dimension comprised between 10 μm and 100 μm, more preferably a minimum dimension comprised between 10 μm and 75 μm.

Particles of this type are typically present in the waste liquid produced by mechanical and/or chemical treatments of the laundry inside the washing drum 4 as tiny particles are released by the laundry. In particular, laundry comprising synthetic materials loses tiny plastic particles fibres, also indicated as microplastics, which are non-biodegradable.

The microparticles filter device 30, therefore, advantageously acts as a microplastics filter device 30.

The microparticles filter device 30 is preferably arranged downstream the objects filter device 28 or, in other words, the objects filter device 28 is preferably arranged upstream the microparticles filter device 30 to advantageously prevent coarse material to reach the microparticles filter device 30 causing a potential damage thereto.

The microparticles filter device 30 according to a preferred embodiment of the invention is better described in detail with reference to FIGS. 4 to 7.

The microparticles filter device 30 preferably shows an elongated shape and preferably extends along a main axis X.

The microparticles filter device 30 comprises a housing body 32, preferably made of a plastic, i.e. polymeric, material.

According to the preferred embodiment illustrated in the FIGS. 1-7, the microparticles filter device 30 is preferably arranged in the upper part of the laundry washing machine 1, more preferably in the upper right side of the laundry washing machine 1. Positioning of the microparticles filter device 30 in the upper position enhances the user interaction with the same microparticles filter device 30.

The microparticles filter device 30 is preferably vertically aligned to the draining pump 24 to keep the pipe length connecting the draining pump 24 with the microparticles filter device 30 as short as possible to reduce the pump 24 strength. The microparticles filter device 30 comprises an inlet 34 for liquid to be filtered, a filtering chamber 36 and an outlet 38 for filtered liquid.

The inlet 34 of the microparticles filter device 30 is connected to a first portion 26a of the outlet pipe 26 and the outlet 38 of the microparticles filter device 30 is connected to a second portion 26b of the outlet pipe 26 which preferably protrudes out of the cabinet 2, preferably from a rear side wall of the cabinet 2.

The second portion 26b of the outlet pipe 26 preferably comprises an end connector on an outer surface, preferably the rear wall, of the cabinet 2 to hydraulically connect the laundry washing machine 1 to a drainage outside the machine 1.

The first portion 26a of the outlet pipe 26 fluidically connects the draining pump 24 and the microparticles filter device 30.

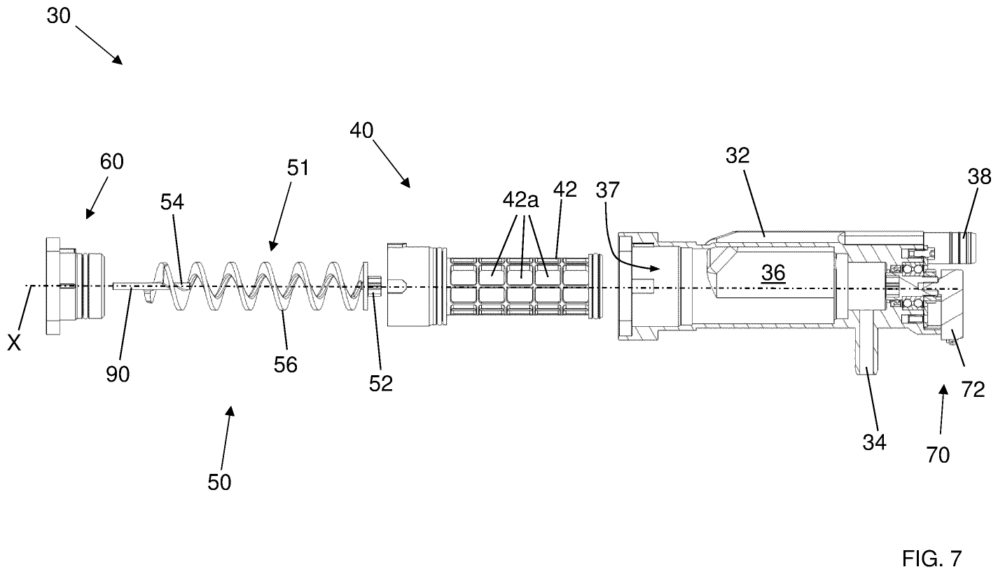

The filtering chamber 36, better visible in FIG. 7, receives therein a microparticles filter element 40 having a filtering surface 42 at which microparticles accumulate while the liquid flows therethrough.

An amount of the volume encased by the housing body 32 defines the filtering chamber 36.

The filtering chamber 36 is thus housed in the housing body 32.

The filtering chamber 36 is preferably cylindrically shaped and the microparticles filter element 40 preferably has a cylindrical tubular shape. The filtering chamber 36 and the microparticles filter element 40 preferably extends along said main axis X. The filtering surface 42 preferably comprises a plurality of meshes 42a, more preferably rectangular meshes 42a (as visible in FIG. 7).

Meshes 42a are preferably realized with a woven wire. In a preferred embodiment the wire is made of polyethylene. Said plurality of meshes 42a can be provided by one or more layers of woven wire covering a plurality of openings formed in a body portion of the microparticles filter element 40.

Preferably, the mesh is chosen to have a mesh size configured to retain particles having a minimum dimension comprised between 0.1 μm and 5 mm, preferably a minimum dimension comprised between 10 μm and 100 μm, more preferably a minimum dimension comprised between 10 μm and 75 μm, as said above.

The microparticles filter element 40 preferably defines an unfiltered volume 43 apt to receive the liquid before its filtration and coming from the inlet 34. According to the preferred embodiment here illustrated, the unfiltered volume 43 corresponds to the inner cylindrical volume of the microparticles filter element 40. In a normal operating condition of the microparticles filter device 30, the liquid is supplied into the unfiltered volume 43 from the inlet 34 and then undergoes to filtration by passing through the microparticles filter element 40, in particular by passing through meshes 42a. The filtered liquid thus reaches an elongated annular chamber 44 that is radially outer the microparticles filter element 40 and that forms part of the filtering chamber 36. The elongated annular chamber 44 hydraulically communicates with the outlet 38 of the microparticles filter device 30.

While the liquid flows through the microparticles filter element 40, microparticles progressively accumulate on the filtering surface 42.

The extension of the filtering chamber 36 along the main axis X substantially corresponds to the filtering area defined by microparticles filter element 40 and, more preferably, defined by said meshes 42a.

Nevertheless, the filtering chamber 36 may comprise portions that extends outside said filtering area and that are preferably used to assemble the microparticles filter element, for example for receiving sealing elements as described later, or for the connection of the microparticles filter element to other parts of the microparticles filter device.

The microparticles filter device 30 is equipped with a cleaning device 50 which is configured to remove microparticles that accumulate on the first side of the filtering surface 42 of the filtering element 40 that the liquid encounters when passing through said filtering surface 42.

The cleaning device 50 is preferably arranged inside the microparticles filter element 40 for moving microparticles it removes from the filtering surface 42 towards a storage volume 61 of a collecting chamber 60. The collecting chamber 60 is arranged at a side, in particular an end side, of the filtering chamber 36 and in communication therewith.

According to the preferred embodiment described herein, the movable cleaning device 50 comprises a rotatable element 51 wiping a side of the filtering surface 42, preferably wiping the first side of the filtering surface 42 that the liquid encounters and where microparticles accumulates. More preferably, the rotatable element 51 may be embodied as a worm having a first end shaft body 52, a second end shaft body 54 and a helix-shaped element 56 connecting the end shaft bodies 52, 54 and winding around a main axis X.

This main axis X corresponds to the direction through which the rotatable element 51 extends. In the preferred embodiment described herein, this main axis X preferably coincides with the main axis X of the microparticles filter device 30.

The helix-shaped element 56 is preferably a circular helix-shaped element 56. The central part of the rotatable element 51, embodied as a worm, between the end shaft bodies 52, 54 and enclosed by the helix-shaped element 56 is therefore void and therefore the rotatable element 51 is embodied as a hollow worm.

In the embodiment described above, the rotatable element 51 is rotated around the main axis X, the helix-shaped element 56 wipes a side of the filtering surface 42 of the microparticles filter element 40 thereby removing microparticles accumulated thereon, and, at the same time, it is able to move microparticles towards the storage volume 61 of the collecting chamber 60, acting as a worm conveyor.

Microparticles are therefore collected into the storage volume 61 of the collecting chamber 60 as the rotatable element 51 rotates. Microparticles removed from the filtering surface 42 are conveyed towards the storage volume 61 of the collecting chamber 60 and towards an opening 37 provided in the housing body 32, such that microparticles can be removed from the microparticles filter device 30 by removing the collecting chamber 60 therefrom.

Preferably, the helix-shaped element 56 of the rotatable element 51 has its terminal part 56a that at least partially extends into the storage volume 61 of the collecting chamber 60.

Advantageously, microparticles moved towards the collecting chamber 60 are pressed in the storage volume 61 by the action of the terminal part 56a of the rotatable element 51. Microparticles are preferably squeezed inside the storage volume 61 with removal of the surplus of liquid contained therein that flow back to the filtering chamber 36. This maximizes the storage of microparticles inside the storage volume 61 and provides for an easy removal of a dried, packed microparticles mass.

Rotation of the rotatable element 51 is preferably obtained through an actuating device 70.

The actuating device 70 is preferably arranged at said first end shaft body 52 of the rotatable element 51 and preferably comprises an electric motor 72 having a rotatable shaft 74 cooperating with the first end shaft body 52 of the rotatable element 51.

An interconnection device 76 is preferably arranged between the first end shaft body 52 of the rotatable element 51 and the rotatable shaft 74 of the electric motor 72. The interconnection device 76 allows transmission of rotation of the rotatable shaft 74 to the rotatable element 51 and also allows disconnection of the rotatable element 51 from the rotatable shaft 74 so that the rotatable element 51 may be removed from the filtering chamber 36, as better described later.

Preferably, the interconnection device 76 comprises a joint element 78 rotatably mounted on the housing body 32 of the microparticles filter device 30 through a ball round bearing 80. The joint element 78 comprises a first end 82 connected to the shaft 74 of the motor 72 and a second end with a seat 84 receiving the first end shaft body 52 of the rotatable element 51. The seat 84 and the first end shaft body 52 of the rotatable element 51 are complementarily shaped, for example a cylindrical shape with a flat portion is used, so that they can rotate together when the rotatable element 51 works/rotates and they can be disconnected when the rotatable element 51 stops, preferably by extracting the rotatable element 51 from the seat 84 when the rotatable element 51 is pulled along the main axis X direction.

According to an aspect of the invention, the collecting chamber 60 is configured to be removably coupled with respect to the housing body 32. The collecting chamber 60 works as a cap for the opening 37, closing the latter when it is coupled to the housing body 32.

According to a preferred embodiment illustrated in FIGS. 4-7, the collecting chamber 60 is preferably screwable to the housing body 32. A male thread 62 of the collecting chamber 60 preferably engages with a female thread 64 on the housing body 32 of the microparticles filter device 30.

Preferably, the collecting chamber 60 is screwable in a first direction to the housing body 32, preferably the clockwise direction, and the rotatable element 51 is also operated/rotated in the same first direction. Advantageously, when the rotatable element 51 is operated/rotated the risk of disconnecting, for example unscrewing, the collecting chamber 60 from the housing body 32 is prevented.

In further preferred embodiments, the collecting chamber may be configured to be removably coupled to the housing body 32 by a pushing or snap-in action.

According to a further aspect of the invention, the cleaning device 50 comprises a portion 90 extending into the storage volume 61 of the collecting chamber 60 thereby providing an extraction aid member 90 to remove the cleaning device 50 from the housing body 32 when the collecting chamber 60 is removed from the housing body 32, as better described later.

According to the preferred embodiment illustrated in FIGS. 4-7, the portion 90 of the cleaning device 50 extending into the storage volume 61 of the collecting chamber 60 is preferably embodied as a portion 90 that protrudes from the filtering chamber 36 and extends into the storage volume 61 of the collecting chamber 60. In this embodiment, the cleaning device 50 extends into the storage volume 61 of the collecting chamber 60 along the axis X for the entire storage volume 61 extension along the same axis X. The volume occupied by the cleaning device portion 90 extending inside the storage volume 61 is about 5% of the storage volume where microparticles are accumulated. In different embodiments, not shown in the drawings, the cleaning device 50 may extend into the storage volume 61 along a direction, for example the axis X in the FIGS. 4-7, for only a part of the storage volume extension along the same direction. The cleaning device may thus have a cantilever end portion.

Preferably, the portion 90 comprises an elongated pin at the second end shaft body 54 of the rotatable element 51. The elongated pin 90 is preferably integrally realized with the rotatable element 51.

The elongated pin 90 and the collecting chamber 60 are preferably removably coupled one another. The elongated pin 90 is preferably received in a supporting seat 63 realized in the storage volume 61 of the collecting chamber 60.

When the rotatable element 51 rotates, the elongated pin 90 rotates within the supporting seat 63. The supporting seat 63 preferably acts as a centering means while the rotatable element 51 works/rotates.

The supporting seat 63 and the elongated pin 90 are shaped, for example both cylindrically shaped, so that the elongated pin 90 may rotate with respect to the supporting seat 63 when the rotatable element 51 rotates while the collecting chamber 60 may be disengaged from the elongated pin 90 when the collecting chamber 60 is removed (for example, unscrewed) from the housing body 32.

The cleaning device 50 and the collecting chamber 60 are therefore preferably removably coupled one another so that the collecting chamber 60 can be disconnected from the cleaning device 50 when the collecting chamber 60 is removed from the housing body 32.

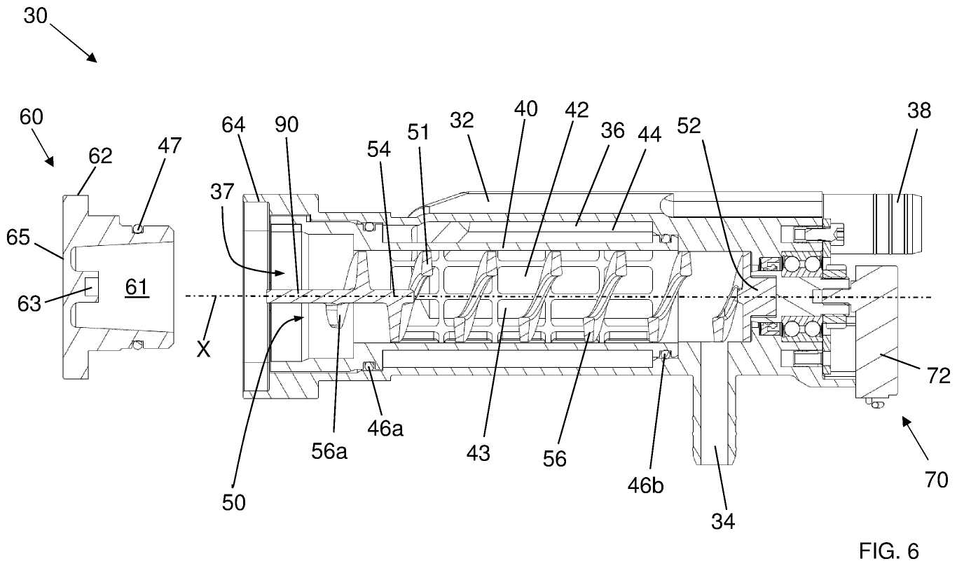

When the collecting chamber 60 is removed (for example, unscrewed) from the housing body 32, as illustrated in FIG. 6, the elongated pin 90 provides an extraction aid member 90 to remove the rotatable element 51 from the housing body 32. The rotatable element 51 is hence also advantageously removable from the filtering chamber 36. In particular, the rotatable element 51 can be removed from the filtering chamber 36 by extracting the rotatable element 51 through the opening 37 of the housing body 32.

The elongated pin 90, in fact, can be usefully grasped by a user and pulled along the main axis X so that the rotatable element 51 disconnects from the joint element 78 and can be fully extracted out of the housing body 32.

Operating position as illustrated in FIG. 6 preferably refers to a maintenance phase of the laundry washing machine 1 when the collecting chamber 60 needs to be removed and then cleaned from microparticles stored in the storage volume 61. As said above, from this operating position the rotatable element 51 may be fully extracted out of the housing body 32 by means of the extraction aid member 90 constituted by the elongated pin 90.

After the rotatable element 51 is fully extracted out of the housing body 32, the microparticles filter element 40 and its filtering surface 42 are advantageously accessible from outside. A user may reach the microparticles filter element 40 and its filtering surface 42 for a proper cleaning process that might be due after a relatively long operation time of the rotatable element 51 wiping a side of the filtering surface 42.

More preferably, the microparticles filter element 40 is removably arranged in the filtering chamber 36. Advantageously, after removal of the collecting chamber 60 the user may also extract the microparticles filter element 40 from the filtering chamber 36 and hence facilitating the cleaning process and/or substitution of the same in case the microparticles filter element 40 is worn out or damaged, as illustrated for example in the operating position of FIG. 7. In particular, the microparticles filter element 40 can be extracted from the filtering chamber 36 through the opening 37 of the housing body 32.

According to a preferred embodiment illustrated in the FIGS. 4-7, the microparticles filter element 40 is preferably removably received in the housing body 32 of the microparticles filter device 30 and may be preferably inserted and extracted along the main axis X, in particular through the opening 37 of the housing body 32. Therefore, the microparticles filter element 40 may be embodied as a disposable filter element that can be substituted, whenever it is necessary.

Between the microparticles filter element 40 and the housing body 32, sealing elements 46a, 46b, for example plastic, i.e. polymeric, O-rings, are preferably arranged to guarantee watertightness of the filtering chamber 36 during the filtering process.

The microparticles filter element 40 preferably extends towards the frontal part of the housing body 32 of the microparticles filter device 30 and preferably receives a portion of the collecting chamber 60 therein.

This facilitates extraction of the microparticles filter element 40 which may be grasped by the user after removal of the collecting chamber 60.

Preferably, a sealing element 47, for example plastic, i.e. polymeric, O-rings, is preferably arranged between the microparticles filter element 40 and the collecting chamber 60 to guarantee watertightness of the filtering chamber 36 during the filtering process.

As said above, the collecting chamber 60 is configured to be removably coupled with respect to the housing body 32 and in the preferred embodiment illustrated in FIGS. 4-7 the collecting chamber 60 is directly connectable, for example screwable, to the housing body 32 through male and female threads 62, 64. In further preferred embodiments, not illustrated, the collecting chamber may be removably coupled with respect to the housing body not directly coupling the collecting chamber to the housing body. For example, the collecting chamber may be removably coupled, e.g. screwable, to the frontal part of the microparticles filter element instead of to the housing body.

In a preferred embodiment illustrated herein, the cabinet 2 comprises an aperture 7, as shown in FIG. 1, so that the collecting chamber 60 of the microparticles filter device 30 is accessible to a user, from outside the cabinet 2.

The aperture 7 is preferably realized in the upper right side of the front side wall 2a of the laundry washing machine 1 and aligned with the microparticles filter device 30.

The collecting chamber 60 is preferably arranged to close the aperture 7 of the cabinet 2 so that said collecting chamber 60 is directly accessible to the user from a part of the cabinet remaining exposed to a user interaction.

More preferably, the microparticles filter device 30 is arranged with respect to said aperture 7 of the cabinet 2 so that the exposed surface 65 of the collecting chamber 60 fits preferably flush with the front side wall 2a of the cabinet 2 of the laundry washing machine 1.

The majority of the microparticles filter device 30 is thus preferably arranged inside the cabinet 2. Parts of the collecting chamber 60 accessible to the user, for example said exposed surface 65 flushing with the front side wall 2a of the cabinet 2, may not be arranged inside the cabinet 2.

In a further preferred embodiment (not shown), the cabinet may comprise an openable door associated to the aperture 7 to give access thereto, and so that the microparticles filter device is preferably completely placed inside the cabinet.

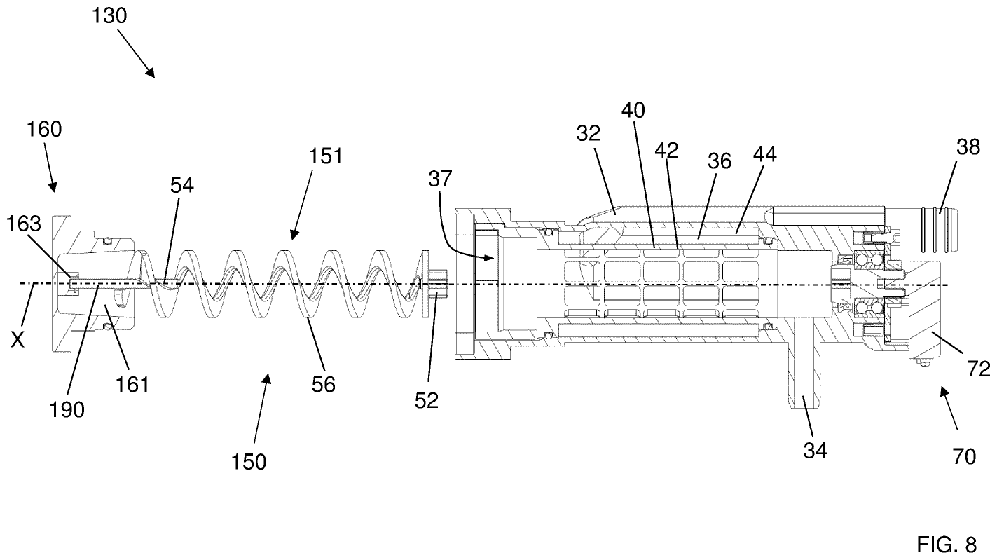

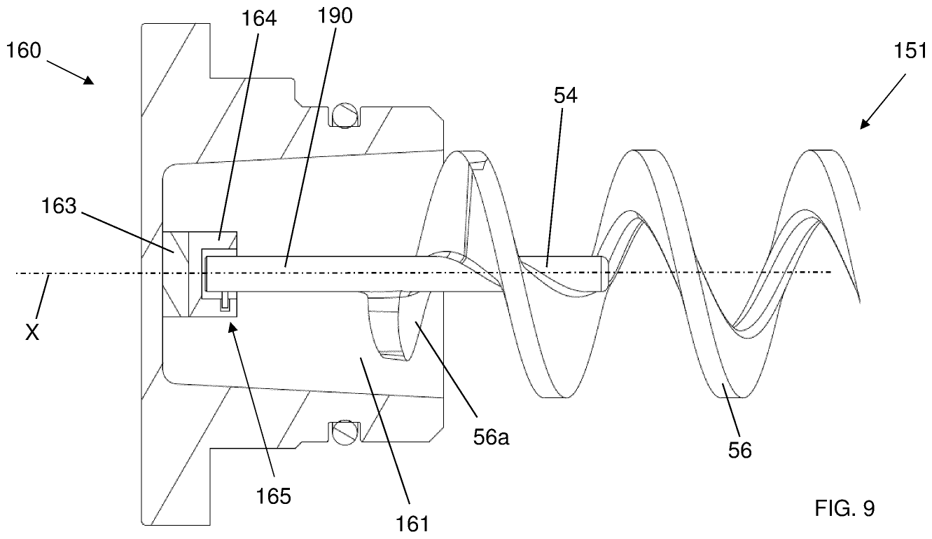

FIGS. 8 and 9 show a further preferred embodiment of the invention which differs from the preferred embodiment previously described in that the rotatable element 151 forming part of the cleaning device 150, still embodied as a worm comprising a helix-shaped element 56, and the collecting chamber 160 of the microparticles filter device 130 are removably connected one another, so that, while the collecting chamber 160 is removed from the filtering chamber 36, the rotatable element 151 preferably remains connected to the collecting chamber 160 and afterwards the collecting chamber 160 may be removed from the rotatable element 151.

In the drawings, corresponding characteristics and/or components of the first embodiment previously described are identified by the same reference numbers.

According to this preferred embodiment, the elongated pin 190 of the rotatable element 151 and the collecting chamber 160 are preferably removably connected one another.

As illustrated in FIG. 9, the elongated pin 190 is removably connected to a first connecting element 164 through a removable locking device 165.

The releasable locking device 165 preferably comprise a releasable bayonet-like locking system.

The first connecting element 164 is rotatable mounted on a second connecting element 163 that is fixedly mounted on the collecting chamber 160. The second connecting element 163 is provided in the storage area 161 of the collecting chamber 160.

When the rotatable element 151 rotates, the elongated pin 190 and the first connecting element 164 rotate together with respect to the second connecting element 163 and the collecting chamber 160.

When the collecting chamber 160 is removed (for example unscrewed) from the housing body 32, the collecting chamber 160 remains engaged with the elongated pin 190. While the collecting chamber 160 is removed (for example unscrewed) from the housing body 32, the elongated pin 190 remains engaged with the collecting chamber 160 and therefore said elongated pin 190 provides an extraction aid member 190 to remove the rotatable element 151 from the housing body 32 and from the filtering chamber 36.

In the operating position illustrated in FIG. 8, which refers to a maintenance phase of the laundry washing machine 1, the collecting chamber 160 and the rotatable element 151 are fully extracted out of the housing body 32 so that the microparticles filter element 40 and its filtering surface 42 are advantageously accessible from outside. A user may reach the microparticles filter element 40 and its filtering surface 42 for a proper cleaning process that might be due after a relatively long operation time of the rotatable element 151 wiping a side of the filtering surface 42. More preferably, as described above, the microparticles filter element 40 is removably arranged in the filtering chamber 36 so that the user may extract the microparticles filter element 40 from the filtering chamber 36 and hence facilitating the cleaning process and/or substitution of the same in case the microparticles filter element 40 is worn out or damaged.

Furthermore, once the collecting chamber 160 has been removed (for example unscrewed) from the filtering chamber 36, the collecting chamber 160 may be removed from the elongated pin 190, and hence from the rotatable element 151, by removing the elongated pin 190 from the first element 164 through the releasable locking device 165.

The collecting chamber 160 can hence be cleaned from microparticles stored in the storage area 161.

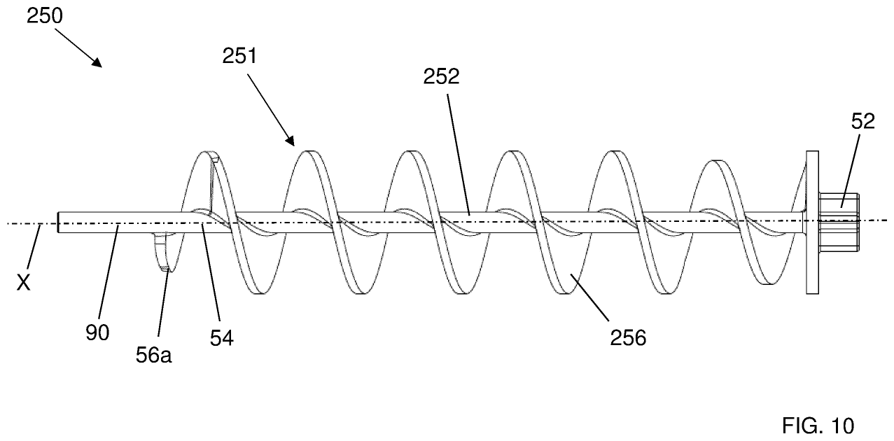

FIG. 10 shows an alternative preferred embodiment of the rotatable element 251 of the invention, forming part of the cleaning device 250, which differs from the preferred embodiment previously described in that the rotatable element 251 is not a hollow worm.

The rotatable element 251 comprises a central shaft body 252 extending along the main axis X between the end shaft bodies 52, 54 and a helix-shaped element 256 that winds around the central shaft body 252, preferably integrally made with the central shaft body 252. The helix-shaped element 256 is preferably a circular helix-shaped element 256. According to this embodiment, the helix-shaped element 256 substantially defines a helicoid.

In the preferred embodiments described above, the cleaning device preferably comprises a rotatable element, in particular a worm, provided with a portion that acts as an extraction aid member.

In further preferred embodiments, the cleaning device may preferably comprise a translatable element wiping a side of the filtering surface of the microparticles filter member.

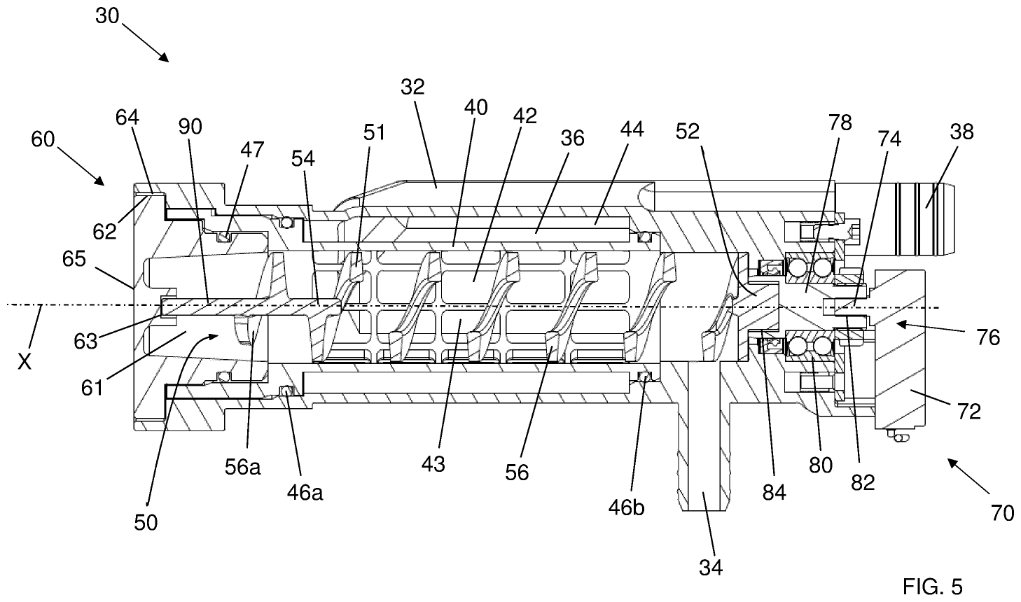

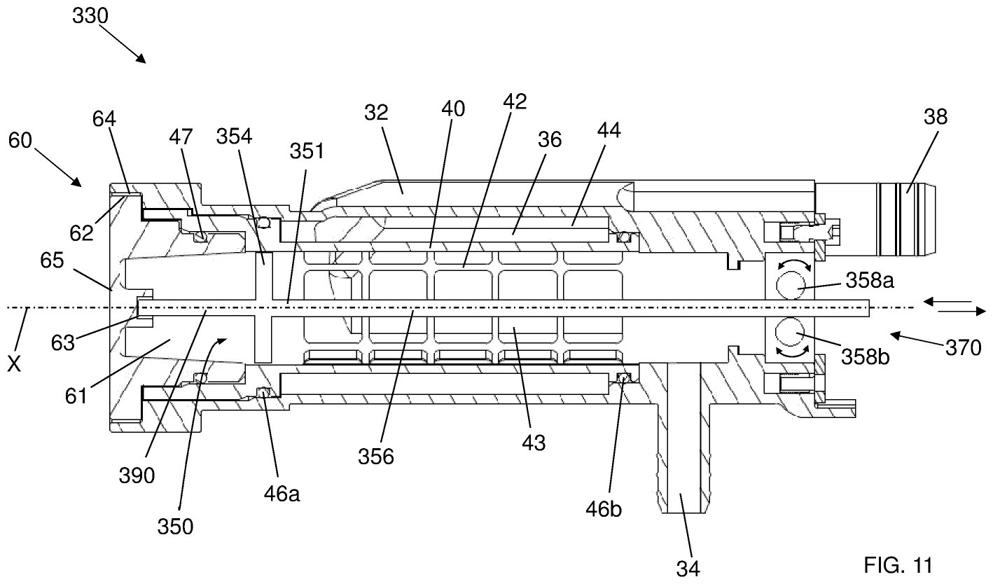

FIG. 11 exemplary shows a solution of this type. In the drawing, corresponding characteristics and/or components of the embodiment described in FIG. 5 are identified by the same reference numbers.

In the microparticles filter device 330 according to this embodiment, the cleaning device 350 comprises a translatable element 351.

The translatable element 351 preferably comprises a piston with a reciprocating rectilinear motion along the main axis direction X.

The piston 351 preferably comprises a head portion 354 and a main shaft 356. External surfaces of the head portion 354 wipes a side of the filtering surface 42 of the microparticles filter element 40. Microparticles removed from the filtering surface 42 are moved towards the collecting chamber 60 by the translation movement of the piston 351.

The reciprocating rectilinear motion of the piston 351 is preferably obtained through an actuating device 370.

The actuating device 370 preferably cooperates with the main shaft 356 of the piston 351 and preferably comprises two wheels 358b, 358b engaging the main shaft 356 and opportunely rotate to move back and forth the piston 351.

The translatable element 351, according to the invention, is further provided with a portion 390 that acts as an extraction aid member 390, as explained above.

In the preferred embodiments described above, the microparticles filter device is associated to the laundry washing machine so as to be preferably arranged within the cabinet of the laundry washing machine.

In further preferred embodiments, the microparticles filter device may be configured to be mounted to an outer side of a cabinet wall and may be fluidly connected to the laundry washing machine draining system. In this way, a user can easily handle the microparticles filter device when it is needed to remove microparticles accumulated therein. In addition, by providing a microparticles filter device mounted to a side of a cabinet wall, i.e. outside of the inner volume defined by the laundry washing machine cabinet walls, it is possible to enlarge the microparticles storage capacity of the filter device, so as to prolong the operation of the filter device before a microparticles removal intervention is required.

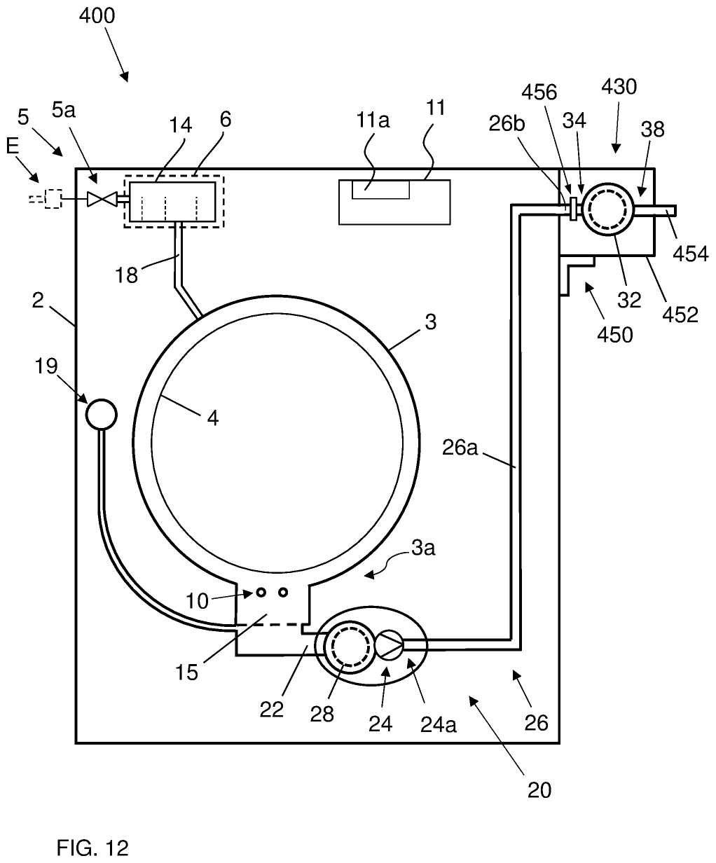

FIG. 12 exemplary shows a solution of this type. In the drawing, corresponding characteristics and/or components of the first embodiment described above, in particular with reference to FIG. 5, are identified by the same reference numbers. According to this embodiment, a microparticles filter device 430 is embodied as a unit provided to the laundry washing machine 400 by being mounted to an outer side of a wall of the outer cabinet 2. The microparticles filter device 430 is preferably mounted to the outer cabinet 2 of the laundry washing machine 400 through a connecting device 450, for example an L-shaped bracket or a hooking device. The microparticles filter device 430 preferably, though not necessarily, comprises an external housing 452 and the latest is preferably connectable/connected to the outer cabinet 2 of the laundry washing machine 400 through said connecting device 450. In another embodiment, the housing body 32 of the microparticles filter device 430 can be provided with connecting members, such as eyelets, allowing the housing body 32 to be mounted to the outer cabinet 2 of the laundry washing machine 400.

The microparticles filter device 430 may be realized according to preferred embodiments as described above, for example the microparticles filter device 30, 130, 330 shown and described above.

According to this embodiment, the inlet 34 of the microparticles filter device 430 is preferably connected to the second portion 26b of the outlet pipe 26 protruding out of the cabinet 2, preferably through a proper hydraulic connector 456.

The outlet 38 of the microparticles filter device 430 is provided for being hydraulically connected to a drainage outside the machine 400, preferably through an outlet pipe 454.

Before the liquid reaches the drainage outside the machine 400, liquid is therefore subjected to a filtration process by means of the microparticles filter device 430, preventing microparticles leaving the laundry washing machine 400.

In a preferred embodiment, the external housing 452 preferably comprises an aperture (not shown) so that the collecting chamber of the microparticles filter device 430 is accessible to a user, from outside the external housing 452. The collecting chamber is preferably arranged to close the aperture of the external housing 432 so that said collecting chamber is directly accessible to the user from a part of the external housing 452 remaining exposed to a user interaction.

More preferably, the microparticles filter device 430 is arranged with respect to said aperture of the external housing 432 so that the exposed surface 65 of the collecting chamber 60 fits preferably flush with a side wall of the external housing 452.

The majority of the microparticles filter device 430 is thus preferably arranged inside the external housing 452. In a further preferred embodiment, the external housing 452 may comprise an openable door associated to the aperture to give access thereto, and so that the microparticles filter device is preferably completely placed inside the external housing 452.

According to this embodiment, advantageously, an existing laundry washing machine may be equipped with a microparticles filter device according to the invention preventing microparticles leaving the laundry washing machine.

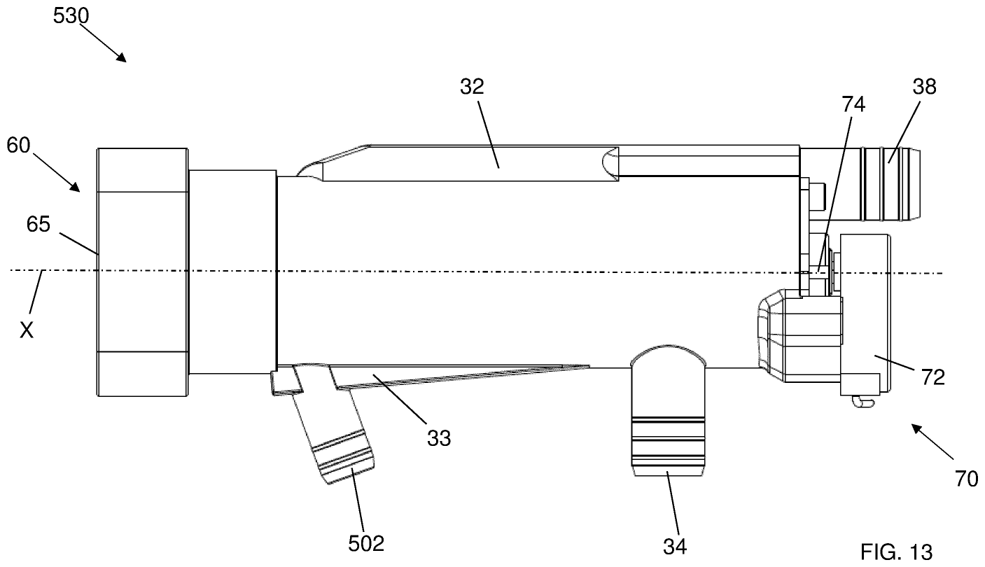

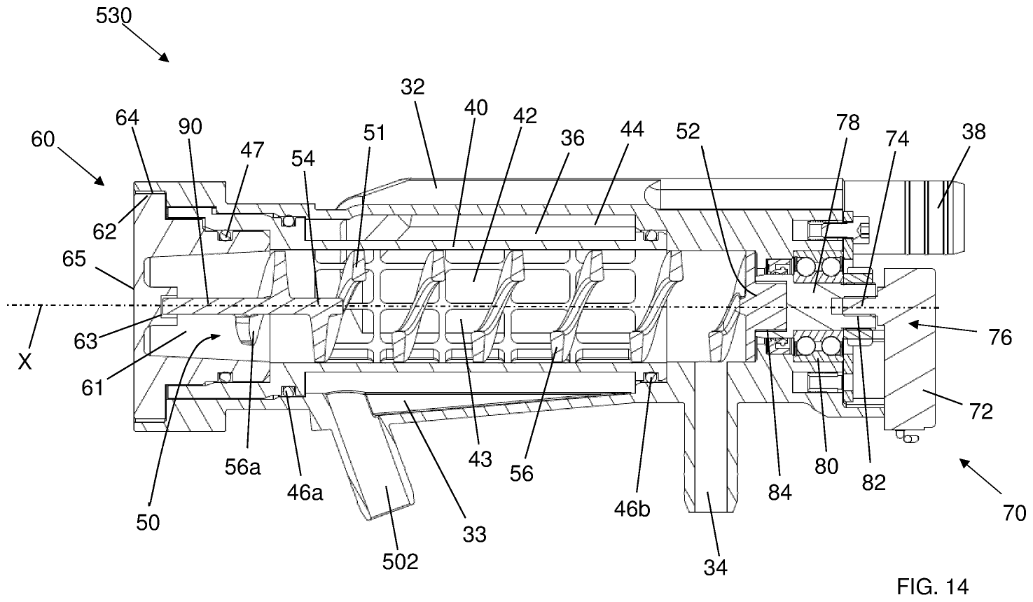

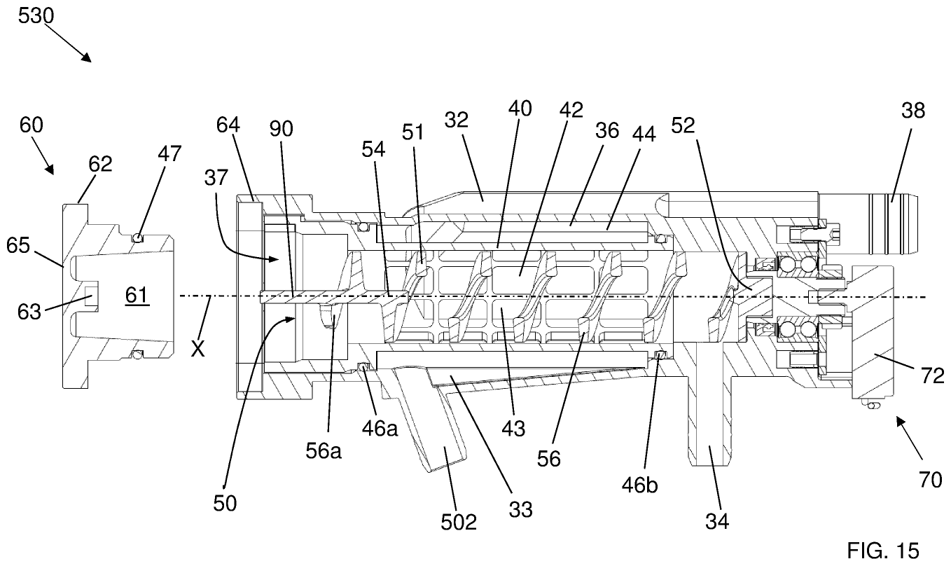

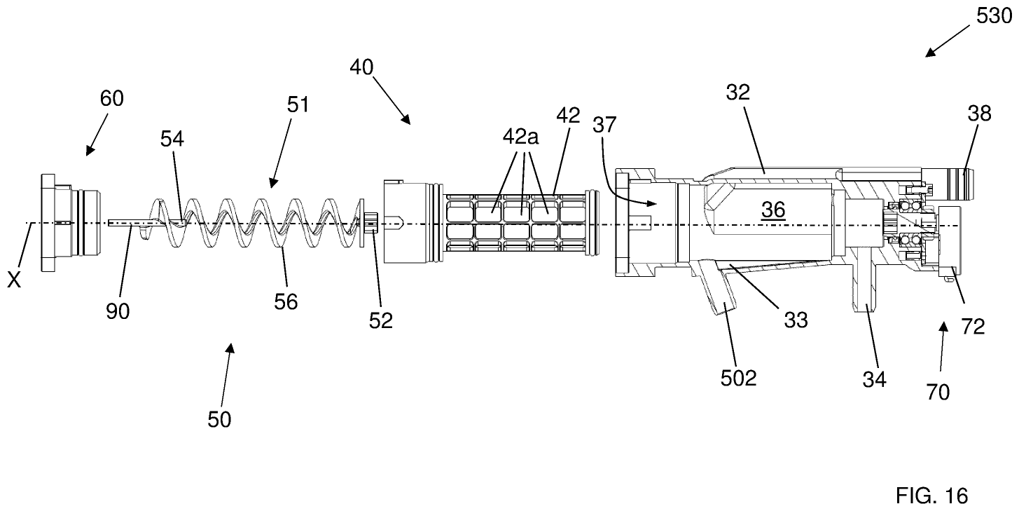

FIGS. 13 to 16 show a further preferred embodiment of the microparticles filter device 530 of the invention which differs from the preferred embodiment previously described with reference to FIGS. 4 to 7 in that the microparticles filter device 530 further comprises a second outlet 502.

In the drawings, corresponding characteristics and/or components of the first embodiment previously described are identified by the same reference numbers.

Preferably, the second outlet 502 is provided in a liquid stagnation or sump portion 33 of the microparticles filter housing body 32. The liquid stagnation or sump portion 33 is preferably embodied as a funnel-shaped part of the main body 32.

Preferably, the second outlet 502 body is provided downstream the microparticles filter element 40 so that liquid that reaches the sump portion 33 is filtered liquid.

According to an aspect of the invention, the second outlet 502 is provided for draining filtered liquid, that is collected in the sump portion 33, from the latter out of the housing body 32, as better described later.

When the microparticles filter device 530 works, the liquid to be filtered is conveyed to the inlet 34 of the microparticles filter device 530 and the filtered liquid is expelled through the outlet 38, as already widely explained above with reference to the microparticles filter device 30 arranged in the draining system 20 of the laundry washing machine 1 (FIGS. 1 to 3) or with reference to the microparticles filter device 430 mounted to an outer side of a wall of the outer cabinet 2 of the laundry washing machine 400 (FIG. 12).

The liquid to be filtered flows through the inlet 34 into the microparticles filter device 530, is then subjected to the filtration process by the microparticles filter element 44 and then expelled through the outlet 38. According to this embodiment, when the microparticles filter device 530 works, the liquid subjected to the filtration process by the microparticles filter element 44 is also expelled through the second outlet 502.

When the microparticles filter device 530 does not work, the liquid to be filtered is not conveyed to the inlet 34 of the microparticles filter device 530 anymore, for example after a washing cycle has terminated.

The filtered liquid that was subjected to the filtration process by the microparticles filter element 44 inside the filtering chamber 36 falls in the sump portion 33 of the housing body 32 by means of gravity force so as to define a residue liquid.

The residue liquid in the sump portion 33 is advantageously expelled through the second outlet 502 and discharged out of the body 32 of the microparticles filter device 530.

Advantageously, liquid expelled through the second outlet 502 and discharged out of the body 32 is a filtered liquid, either when the microparticles filter device 530 works or does not work.

Still advantageously, when the microparticles filter device 530 does not work and according to an advantageous aspect of the invention, residue liquid inside the filtering chamber 36 from the sump portion 33 is expelled through the second outlet 502 and discharged out of the body 32 of the microparticles filter device 530. The filtering chamber 36 thus remains completely emptied and gets dry.

Removal of any residue liquid in the filtering chamber 36 avoids proliferation of bacteria and/or yeasts thus improving hygienic conditions and preventing bad smells.

Furthermore, removal of any residue liquid in the filtering chamber 36 avoids that liquid may spill outside, and eventually falling on the floor, when the collecting chamber 60 is removed, preferably unscrewed, from the housing body 32 and/or when the rotatable element 51 is extracted from the filtering chamber 36 and/or when the microparticles filter element 40 is extracted from the filtering chamber 36.

The microparticles filter device 530 according to this embodiment and according to an aspect of the invention, is preferably associated to a laundry washing machine.

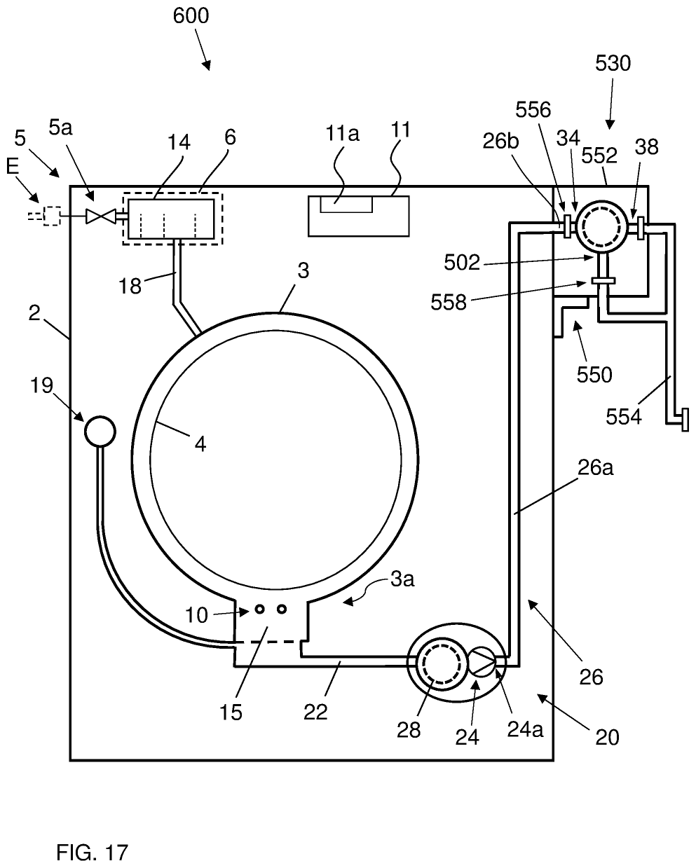

For example, as illustrated in FIG. 17, the microparticles filter device 530 may be mounted to an outer side of a cabinet wall of a laundry washing machine 600 and may be fluidly connected to the laundry washing machine draining system. In this way, as said above, a user can easily handle the microparticles filter device 530 when it is needed to remove microparticles accumulated therein. In addition, by providing a microparticles filter device mounted to a side of a cabinet wall, i.e. outside of the inner volume defined by the laundry washing machine cabinet walls, it is possible to enlarge the microparticles storage capacity of the filter device, so as to prolong the operation of the filter device before a microparticles removal intervention is required.

In further preferred embodiments, not shown, the microparticles filter device may be preferably arranged within the cabinet of the laundry washing machine and fluidly connected to the laundry washing machine draining system.

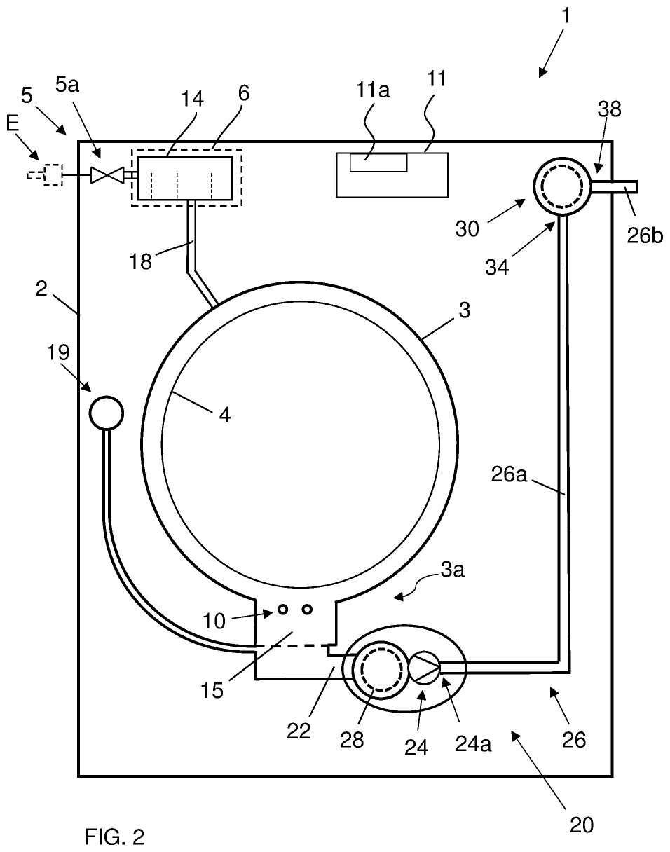

In FIG. 17, corresponding characteristics and/or components of the laundry washing machine of first embodiment described above, in particular with reference to FIG. 2, are identified by the same reference numbers.

According to this embodiment, the microparticles filter device 530 is embodied as a unit provided to the laundry washing machine 600 by being mounted to an outer side of a wall of the outer cabinet 2. The microparticles filter device 530 is preferably mounted to the outer cabinet 2 of the laundry washing machine 600 through a connecting device 550, for example an L-shaped bracket or a hooking device. The microparticles filter device 530 preferably, though not necessarily, comprises an external housing 552 and the latest is preferably connectable/connected to the outer cabinet 2 of the laundry washing machine 600 through said connecting device 550. In another embodiment, the housing body 32 of the microparticles filter device 530 can be provided with connecting members, such as eyelets, allowing the housing body 32 to be mounted to the outer cabinet 2 of the laundry washing machine 600.

The microparticles filter device 530 may be preferably realized according to a preferred embodiment as described above with reference to FIGS. 13 to 16.

According to this embodiment, the inlet 34 of the microparticles filter device 530 is preferably connected to the second portion 26b of the outlet pipe 26 protruding out of the cabinet 2, preferably through a proper hydraulic connector 556.

The outlet 38 of the microparticles filter device 530 is preferably provided for being hydraulically connected to a drainage outside the machine 600, preferably through an outlet pipe 554.

The second outlet 502 of the microparticles filter device 530 is preferably provided for being fluidly connected to an external drainage. In the preferred embodiment illustrated herein, the second outlet 502 is preferably provided for being hydraulically connected to the outlet pipe 554, preferably through a proper hydraulic connector 558.

In a preferred embodiment, the external housing 552 preferably comprises an aperture (not shown) so that the collecting chamber of the microparticles filter device 530 is accessible to a user, from outside the external housing 552. The collecting chamber is preferably arranged to close the aperture of the external housing 552 so that said collecting chamber is directly accessible to the user from a part of the external housing 552 remaining exposed to a user interaction.

More preferably, the microparticles filter device 530 is arranged with respect to said aperture of the external housing 552 so that the exposed surface 65 of the collecting chamber 60 fits preferably flush with a side wall of the external housing 552.

The majority of the microparticles filter device 530 is thus preferably arranged inside the external housing 552. In a further preferred embodiment, the external housing 552 may comprise an openable door associated to the aperture to give access thereto, and so that the microparticles filter device is preferably completely placed inside the external housing 552.

According to this embodiment, advantageously, an existing laundry washing machine may be equipped with a microparticles filter device according to the invention preventing microparticles leaving the laundry washing machine.

In a further preferred embodiment, not shown, a manual valve is preferably associated to the second outlet. In this case, the user may decide if, or when, the second outlet has to perform its function of discharging out of the body of the microparticles filter device the residue liquid.

It has thus been shown that the present invention allows all the set objects to be achieved. In particular, the invention makes possible to provide a microparticles filter device that allows maintenance of a microparticles filtering element, such as cleaning or replacing operations of the filtering element, with respect to the known laundry washing machines.

While the present invention has been described with reference to particular embodiments shown in the figures, it should be noted that the present invention is not limited to the specific embodiments illustrated and described herein; on the contrary, further variants of the embodiments described herein fall within the scope of the present invention, which is defined in the appended claims.

1. A microparticles filter device for a laundry washing machine, the microparticles filter device comprising:
a housing body;
an inlet for liquid to be filtered;
a filtering chamber housed in the housing body, the filtering chamber comprising a microparticles filter element having a filtering surface on which microparticles accumulate while the liquid flows therethrough;
an outlet for filtered liquid; and
a cleaning device movably arranged in the filtering chamber for removing microparticles that accumulate on the filtering surface, the cleaning device moving microparticles removed from the filtering surface towards a storage volume of a collecting chamber arranged at a side of the filtering chamber and in communication therewith;
wherein the collecting chamber is configured to be removably coupled with respect to the housing body and wherein the cleaning device comprises at least a portion extending into the storage volume of the collecting chamber thereby providing an extraction aid member to remove said cleaning device from said housing body when the collecting chamber is removed from the housing body.

2. The microparticles filter device according to claim 1, wherein the microparticles filter element is removably arranged in the filtering chamber.

3. The microparticles filter device according to claim 1, wherein the cleaning device is configured to be removably coupled to the filtering chamber.

4. The microparticles filter device according to claim 3, wherein the cleaning device comprises a rotatable element configured to remove microparticles that accumulate on the filtering surface.

5. The microparticles filter device according to claim 4, wherein the rotatable element comprises:
a worm comprising a first end shaft body;
a second end shaft body and a helix-shaped element connecting the first and second end shaft bodies; and winding around a main axis.

6-7. (canceled)

8. The microparticles filter device according to claim 1, wherein the cleaning device comprises a translatable element provided for wiping a side of the filtering surface.

9. The microparticles filter device according to claim 1, comprising an actuating device for moving the cleaning device.

10. The microparticles filter device according to claim 9, wherein the actuating device comprises an electric motor.

11. The microparticles filter device according to claim 1, wherein the cleaning device and the collecting chamber are removably coupled one another, so that when the collecting chamber is removed from the housing body the collecting chamber is disconnected from the cleaning device.

12. The microparticles filter device according to claim 1, wherein the cleaning device and the collecting chamber are removably connected one another by means of a releasable locking device, so that they can be disconnected one from the other by releasing the releasable locking device after being unitarily removed from the housing body.

13. The microparticles filter device according to claim 1, wherein the collecting chamber is screwable to the housing body.

14. The microparticles filter device according to claim 1, wherein the microparticles filter element is a disposable filter element.

15. The microparticles filter device according to claim 1, further comprising a second outlet provided in a sump portion of the housing body and downstream the microparticles filter element, the second outlet being provided for draining filtered liquid from the sump portion out of the housing body.

16. The microparticles filter device according to claim 15, wherein filtered liquid flows through the second outlet either when a liquid flow entering the inlet is passed through the microparticles filter element or when no liquid flow enters the inlet and an amount of filtered liquid is received in the sump portion.

17. The microparticles filter device according to claim 1, wherein the microparticles filter device is a filter suitable to retain particles having a minimum dimension ranging from 0.1 μm and 5 mm.

18. A method for removing a cleaning device of a microparticles filter device according to claim 1, comprising the steps of:
removing the collecting chamber from the housing body; and
removing the cleaning device from the housing body by means of the extraction aid member.

19. The method according to claim 18, wherein the step of removing the cleaning device from the housing body by means of the extraction aid member is performed after the step of removing the collecting chamber from the housing body wherein, after the collecting chamber has been removed, the extraction aid member is accessible to a user.

20. The method according to claim 18, wherein the step of removing the collecting chamber from the housing body and the step of removing the cleaning device from the housing body are performed simultaneously, wherein the collecting chamber and the extraction aid member remain engaged while the collecting chamber is removed from the housing body.

21. The method according to claim 20, further comprising a step of disengaging the extraction aid member from the collecting chamber after the extraction aid member and the collecting chamber have been simultaneously removed from the housing body.

22. The method according to claim 18, wherein, before the step of removing the collecting chamber from the housing body, filtered liquid collected in a sump portion of the housing body is drained outside the housing body through a second outlet.
